(19) United States
(12) Patent Application Publication
(10) Pub. No.: US 2011/0024592 A1
(43) Pub. Date: Feb. 3, 2011

(54) MOUNTING MECHANISM FOR RETAINING SLIDE RAIL TO CHASSIS

(75) Inventors: MO-MING YU, Shenzhen City (CN); ZE-HONG CHEN, Shenzhen City (CN); GUANG-HUA GU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., SHENZHEN CITY (CN); HON HAI PRECISION INDUSTRY CO., LTD., TU-CHENG (TW)

(21) Appl. No.: 12/615,236

(22) Filed: Nov. 9, 2009

(30) Foreign Application Priority Data
Jul. 31, 2009 (CN) 200910305057.1

(51) Int. Cl. F16M 13/00

(52) U.S. Cl. 248/309.1

(57) ABSTRACT

A mounting mechanism is disclosed. The mounting mechanism includes a chassis with an anchor member, a slide rail defining a mounting slot for receiving the anchor member, and a retaining member fixed to the slide rail. The retaining member includes a main body and an operating portion extending slantingly from a first end of the main body. A stop portion is formed from a second end of the main body opposite to the operating member. The stop portion is capable of retaining the anchor member in the mounting slot of the slide rail. The operating portion is manipulated to pivot towards the slide rail to urge the main body of the retaining member to rotate away from the first surface, until the anchor member is disengaged from the stop portion of the retaining member.

### CROSS-REFERENCE TO RELATED APPLICATION

The relevant subject matter is disclosed in co-pending U.S. patent applications (Attorney Docket Nos. US28364 and US28365) filed on the same date and entitled “MOUNTING MECHANISM FOR RETAINING SLIDE RAIL TO CHASSIS”, which are assigned to the same assignee as this patent application.

### BACKGROUND

1. Technical Field

The present disclosure relates to mounting mechanisms, and more particularly to a mounting mechanism for mounting a slide rail to a chassis.

2. Description of Related Art

A typical slide rail assembly for a server chassis and a rack includes an outer slide rail mounted to the rack, an inner slide rail mounted to the chassis, and an intermediate slide rail mounted between the outer and inner slide rails. The intermediate slide rail is extendable relative to the outer slide rail, and the inner slide rail is extendable relative to the intermediate slide rail, thereby the chassis can be extended a distance out from the rack. Conventionally, the inner rail is secured to a side of the chassis with a plurality of screws. Therefore, a tool, such as a screwdriver, is needed for installing and detaching the slide rail, and the processes are tedious and time consuming.

### BRIEF DESCRIPTION OF THE DRAWINGS

FIG. 1 is a partial, exploded, isometric view of an exemplary embodiment of a mounting mechanism.

FIGS. 2-4 are assembled, isometric views of the mounting mechanism of FIG. 1, showing different using states.

### DETAILED DESCRIPTION

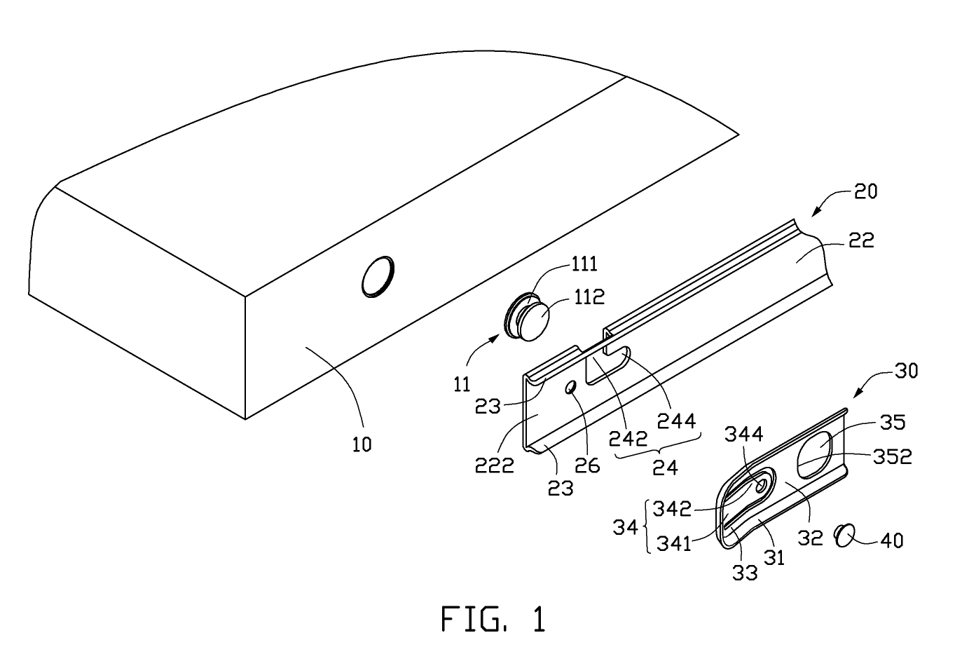

Referring to FIG. 1, an exemplary embodiment of a mounting mechanism includes a chassis 10, a slide rail 20, and a retaining member 30 coupled to the slide rail 20.

The chassis 10 includes an anchor member 11 mounted to a sidewall of the chassis. The anchor member 11 is a mushroom-shaped post, and includes a neck portion 111 and a head portion 112 wider in diameter than the neck portion 111.

The slide rail 20 has a generally C-shaped cross-section, and includes a main wall 22 with a first surface 222 opposite to the chassis 10 and two sidewalls 23 extending from opposite sides of the main wall 22 opposite to the chassis 10. The main wall 22 defines a generally J-shaped mounting slot 24, in the vicinity of one end of the main wall 22. The mounting slot 24 includes an upright guiding portion 242 and a horizontal positioning portion 244 communicating with the guiding portion 242. A coupling hole 26 is defined in the main wall 22, in the vicinity of the mounting slot 24.

The retaining member 30 is integrally formed with a resilient piece. A flange 31 is formed by bending edges of the retaining member 30, for reinforcing the retaining member 30. The retaining member 30 includes a main body 32, an operating portion 33 extending slantingly from a first end of the main body 32, and a tongue-shaped connecting portion 34 extending from the flange 31 at the operating portion 33 towards the main body 32. A U-shaped channel is defined in the retaining member 30 partially bounding the tongue-shaped connecting portion 34. The connecting portion 34 includes a resilient section 341 connected to the flange 31, and a bent section 342 at a distal end of the connecting portion. A mounting hole 344 is defined in the bent section 342. The bent section 342 of the connecting portion 34 is substantially coplanar with the main body 32. The resilient section 341 is substantially coplanar with the operating member 33. A through slot 35 is defined in a second end of the main body 32 opposite to the operating portion 33, for receiving the head portion 112 of the anchor member 11. A stop portion 352 is formed on a wall bounding the through slot 35.

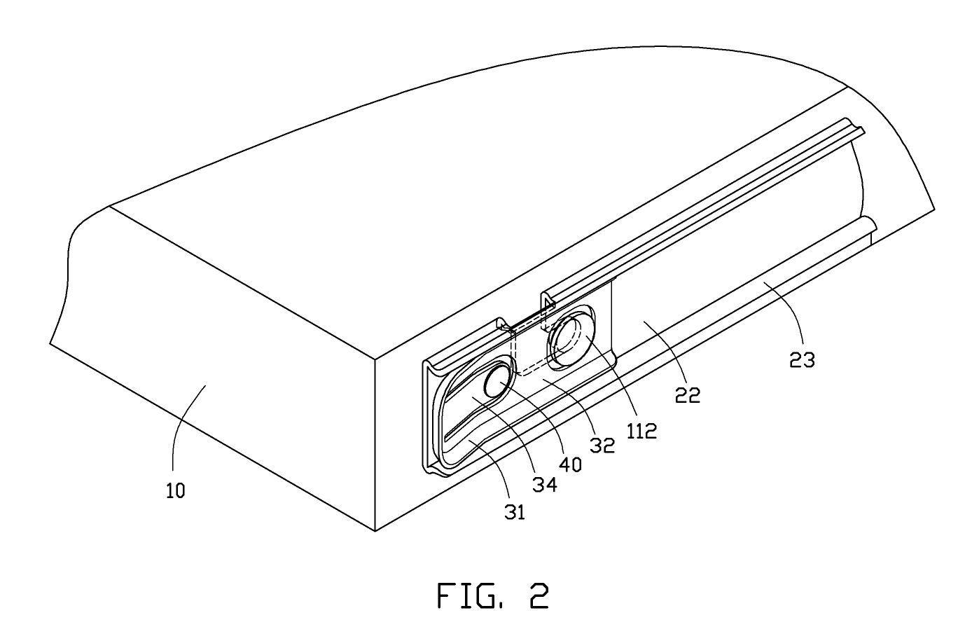

Referring to FIG. 2, in assembly, a fastener 40, such as a rivet, extends through the mounting hole 344 of the retaining member 30, to engage in the coupling hole 26 of the slide rail 20, thereby attaching the retaining member 30 to the slide rail 20. The through slot 35 of the retaining member 30 is aligned with the positioning portion 244 of the mounting slot 24 of the slide rail 20. The main body 32 and the bent section 342 of the connecting portion 34 are in tight contact with the first surface 222 of the slide rail 20. The operating portion 33 and the resilient section 341 of the connecting portion 34 slant outward from the first surface 222 of the slide rail 20.

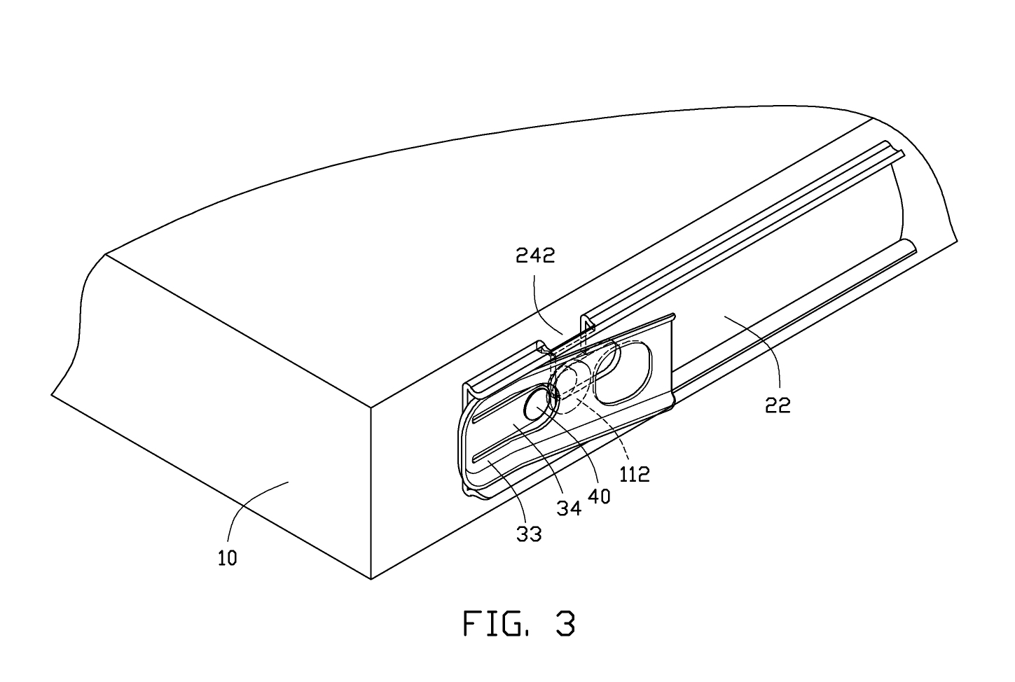

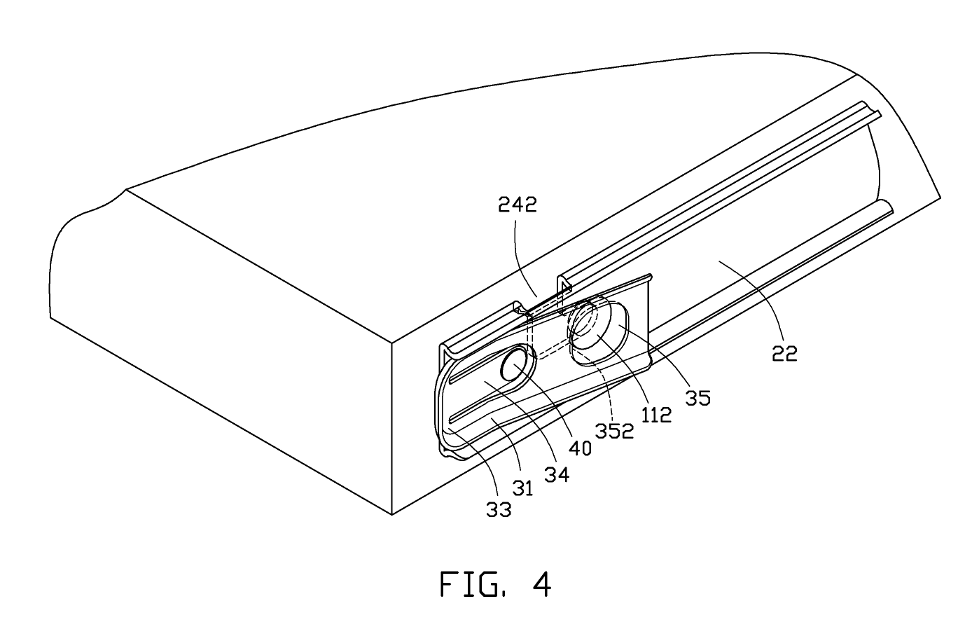

Referring to FIGS. 3 and 4, to mount the slide rail 20 to the chassis 10, the chassis 10 is moved to fit the neck portion 111 of the anchor member 11 into the mounting slot 24 from the guiding portion 242 to the positioning portion 244. The head portion 112 of the anchor member 11 drives the main body 32 of the retaining member 30 away from the first surface 222. Therefore the operating portion 33 is rotated towards the first surface 222 of the slide rail 20 to deform the resilient section 341 of the connecting portion 34. When the neck portion 111 of the anchor member 11 slides into the positioning portion 244 of the mounting slot 24, the resilient section 341 of the connecting portion 34 is restored to cause the retaining member 30 to rotate towards the first surface 222 of the slide rail 20, until the stop portion 352 engages with the head portion 112 of the anchor member 11, to retain the anchor member 11 in the positioning portion 244 of the mounting slot 24. Therefore, the slide rail 20 is secured to the chassis 10.

To detach the slide rail 20 from the chassis 10, the operating portion 33 is manipulated to pivot around the fastener 40 and towards the first surface 222 of the slide rail 20 in a direction perpendicular to the first surface 222 of the slide rail 20, with the resilient section 341 of the connecting portion 34 being deformed. The main body 32 of the retaining member 30 is rotated away from the first surface 222, until the head portion 112 of the anchor member 11 is disengaged from the stop portion 352 of the retaining member 30. The chassis 10 is moved to allow the neck portion 111 of the anchor member 11 to slide out of the positioning portion 244 of the mounting slot 24, and then slide out of the guiding portion 242 of the mounting slot 24. Thereby, the slide rail 20 may be detached from the chassis 10.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A mounting mechanism comprising:
a chassis comprising an anchor member fixed to the chassis;
a slide rail defining a mounting slot for receiving the anchor member of the chassis; and
a retaining member comprising a main body, an operating portion extending slantingly from a first end of the main body, a stop portion formed from a second end of the main body opposite to the operating portion, and a tongue-shaped connecting portion extending from the operating portion towards the stop portion, wherein the connecting portion comprises a resilient section connected to the operating portion and a bent section fixed to the slide rail, the stop portion is operable of retaining the anchor member in the mounting slot of the slide rail;
wherein the operating portion is operable to be manipulated to pivot towards the slide rail to urge the main body of the retaining member to rotate away from the slide rail, such that the anchor member is disengaged from the stop portion of the retaining member.

2. The mounting mechanism of claim 1, wherein the anchor member is a mushroom-shaped post, and comprises a neck portion and a head portion with a diameter larger than a diameter of the neck portion, the neck portion of the anchor member is slidable in the mounting slot of the slide rail, the head portion of the anchor member is engagable with the stop portion of the retaining member.

3. The mounting mechanism of claim 2, wherein the mounting slot is generally J-shaped and comprises an upright guiding portion for the anchor member entering into the mounting slot, and a horizontal positioning portion for the neck portion of the anchor member engaged therein.

4. The mounting mechanism of claim 1, wherein a flange extends from edges of the retaining member, for reinforcing the retaining member.

5. The mounting mechanism of claim 1, wherein the retaining member is integrally formed with a resilient piece.

6. The mounting mechanism of claim 1, wherein a U-shaped channel is defined in the retaining member, to bound the tongue-shaped connecting portion.

7. The mounting mechanism of claim 1, wherein the bent section of the connecting portion is substantially coplanar with the main body.

8. The mounting mechanism of claim 1, wherein the resilient section of the connecting portion is substantially coplanar with the operating member.

9. The mounting mechanism of claim 1, wherein a through slot is defined in the second end of the main body, the stop portion is formed on a wall bounding the through slot.

10. A slide rail assembly comprising:
a slide rail defining a mounting slot therein, to receive an anchor member; and
a retaining member comprising a main body parallel to the slide rail, an operating portion extending slantingly from a first end of the main body, a stop portion formed from a second end of the main body opposite to the operating portion, and a connecting portion extending from the operating portion towards the stop portion, wherein the connecting portion comprises a resilient section connected to the operating portion and a bent section extending from the resilient section fixed to the slide rail, the main body and the bent section of the connecting portion are in tight contact with the slide rail, the operating portion and the resilient section of the connecting portion slant outward from the slide rail, the stop portion is capable of retaining the anchor member in the mounting slot of the slide rail;
wherein the operating portion is operable to be manipulated to pivot towards the slide rail to urge the main body of the retaining member to rotate away from the slide rail, such that the anchor member is disengaged from the stop portion of the retaining member.

11. The slide rail assembly of claim 10, wherein the mounting slot is generally J-shaped and comprises an upright guiding portion for the anchor member entering into the mounting slot, and a horizontal positioning portion for the neck portion of the anchor member being engaged therein.

12. The slide rail assembly of claim 10, wherein a flange extends from edges around the retaining member, for reinforcing the retaining member.

13. The slide rail assembly of claim 10, wherein the retaining member is integrally formed with a resilient piece.

14. The slide rail assembly of claim 10, wherein a U-shaped channel is defined in the retaining member to bound the tongue-shaped connecting portion.

15. The slide rail assembly of claim 10, wherein the bent section of the connecting portion is substantially coplanar with the main body.

16. The slide rail assembly of claim 10, wherein the resilient section is substantially coplanar with the operating member.

17. The slide rail assembly of claim 10, wherein a through slot is defined in the second end of the main body, the stop portion is formed on a wall bounding the through slot.
